(19) United States
(12) Patent Application Publication
(10) Pub. No.: US 2008/0220212 A1
(43) Pub. Date: Sep. 11, 2008

(54) Composite Film for Packing Foods and the Process of Making it

(75) Inventors: David Lin, Tainan County (TW); Irene Lin, Tainan County (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: DAVID LIN, TAINAN COUNTY, R.O.C (TW)

(21) Appl. No.: 10/592,078

(22) PCT Filed: Mar. 9, 2004
(86) PCT No.: PCT/CN04/00188

§ 371 Date: Jul. 30, 2007

(51) Int. Cl. B32B 3/10; B32B 38/04

(52) U.S. Cl. 428/138; 156/256

(57) ABSTRACT

A composite film for packaging foods enable to regulate pressure inside automatically when being heated and the progress of making it are provided. The composite film comprises a substrate film provided with a plurality of micro-gap regions processed by impressing process and an adhesive film attached to an airtight film. The composite film is applied to a food packaging devices which has an airtight structure. In use, the food packaging device can receive foods for microwave heating while the airtight film and the micro-gap region are used to prevent the food packaging device from breaking while preventing the steam vast losing and foods from becoming drier.

### FIELD OF THE INVENTION

The present invention relates to a composite film for packaging foods and the process of making it, and more particularly to a composite film applied to various food packaging containers or bags for receiving frozen foods or refrigerated foods, the composite film adapted to be tightly sealed, and when heated by microwave oven, the composite film is able to suitably regulate high-temperature pressurized vapor generated by the microwave heating so as to prevent the food packaging containers or bags from breaking, and retaining most of the high-temperature vapor while maintaining the original flavor of the foods therein.

### BACKGROUND OF THE INVENTION

Conventionally, foods can be selectively heated by roasting, boiling, or steaming. In another aspect, cooking foods by microwave with high-energy efficiency has been developed and used more than at least 50 years. In industrialized countries, based on convenience and quickness, heating foods by microwave ovens is common in homes, schools, restaurants, or other public places.

The principle of heating foods by microwave is that polar molecules of various compositions contained in a heated material have dipole moments. In an electromagnetic vector field of the microwaves, the dipole moments of the polar molecules intensely vibrate and turn to align with the electromagnetic field direction. The heated material has a damping effect capable of converting vibration energy generated by the dipole moments of the polar molecules into heat energy by frictional dissipation so as to increase internal energy and temperature of an internal system of the heated material. Generally, the more intense the dipole moments of the polar molecules are (i.e. the higher the relatively dielectric constant of the polar molecules are), the higher the conversion ratio from the microwave energy into heat energy is (i.e. the higher the temperature rising and heating of the heated material are). The relatively dielectric constant of pure water in room temperature is close to 80 while that of polyethylene (PE) is 2.51. Thereby, when heating water-rich foods received in a PE packaging material by microwaves, most of microwave energy is converted into heat energy by water molecules of the water-rich foods in principle. In other words, temperature rising of a heated system is dependent on foods but not the packaging material because the packaging material only has a lower heat conversion not enough to raise temperature quickly. Furthermore, microwaves has a property of general electromagnetic waves to penetrate all portions of a heated material for uniformly heating the heated material while raising temperature of an internal system of the heated material by converting the vibration energy into heat energy by ways of frictional dissipation of the damping of the heated material. It is understood that the higher the heat conversion of molecular damping of the heated material is, the higher the temperature of the heated material is raised, and the more completely the cooked material is heated. In industry and consumer society, microwaves is commonly used to heat, dry, cook, roast, bake, or sterilize a processed food, wherein the microwaves is generally selected from electromagnetic waves ranged from 915 MHz to 2450 MHz. Moreover, the relatively dielectric constant of food material and the frequency of microwave are related to the temperature of the microwave heating.

Two main problems occurring during heating and cooking foods by microwave in an open space are that foods lose water too fast, and become too dried after heated. It is because foods contain high volatile compositions with high dielectric constant, such as water, which can convert microwave energy into heat energy under an electromagnetic vector field of the microwave so as to raise temperature of the foods. It is resulted in that the high volatile compositions with high vaporization absorb heat energy and quickly evaporate away from the foods, and the foods become drier to lose the original flavor thereof.

In microwave heating application, common commercial packaging material applied to microwave ovens includes wrap film, special microwave bag, special microwaveable container, and etc. The packaging material is selected from the group consisting of polyethylene (PE), polypropylene (PP), polyamide (nylon), polycarbonate (PC), polyvinyl chloride (PVC), polyvinylidene chloride (PVDC), polymethylpentene (PMP), ethylene-vinyl acetate (EVA), polyurethane (PU), Surlyn™ (Dupont ionomer), polyethylene terephthalate (PET), polyvinyl alcohol (PVA), paper, synthetic paper, glassine paper, waxed paper, ceramic, glass, and the combination thereof. The packaging material can be constructed into mono-layer structure, multi-layer structure, or foamed form.

In fact, based on manufacturing convenience of the packaging material formulation, plasticizer additives are commonly added into the packaging material. However, the plasticizer additives of the packaging material are directly in contact with foods during packaging, storing, transporting, or heating by microwave so that the plasticizer additives contaminate the foods to danger health of food consumers.

To overcome the problem as described above, the Food and Drug Administration (FDA) of the United States of America and the Department of Health in Taiwan legislate for requirement and standard about food packaging material. Except for the requirement that foods can not be contaminated by the packaging material, related requirement about thermal stability and thermal degradation of the packaging material under high and low temperature is included.

In recent years, because the knowledge of consumers and the socio-economic level are increasing, the consumers have higher acceptability to use microwave ovens based on higher energy efficiency, high cooking convenience, and quickly heating of the microwave ovens. Thus, it is important to develop special packaging material applied to microwave heating, which can be used in various usage temperature and humid conditions while having low manufacturing cost and convenience of use.

In another aspect, when a packed food of airtight type are heated by microwaves, a phenomenon called “air burst” may happen in a food packaging bag of the packed food because heat energy quickly raises internal air temperature and internal build up over pressure in the food packaging bag. To prevent the problem as described above, suppliers of conventional food packaging material suggest that pre-forming an opening on food packaging bags or food packaging containers before heating or cooking by microwaves so that the build up internal high temperature pressurized vapor generated during heating or cooking can be suitably dissipated to prevent the air burst phenomenon. An American corporation, Ziploc, suggests that a frozen-food zipper storage bag for frozen food which can be heated by microwaves must be pre-opened a ventilation hole thereon before heating so as to prevent the air burst phenomenon and any accident. However, the way to use the food packaging bag causes an inner space of the food packaging bag communicates with the atmosphere so that most of high volatile compositions of foods received in the packaging bag may be lost during microwave heating and the foods become too dried after heated to lose the original flavor thereof.

Conventional food packaging bag including sealed type or detachable type like zipper bag has a sealed packing space for receiving foods. If heating the foods with the food packaging bag by microwave oven, internal temperature and pressure of the sealed packing space caused by evaporation of high volatile composition of the foods increase over the time so that the build up internal steam pressure thereof may be greater than threshold limit value of tension of the food packaging bag. It is resulted in that the air burst phenomenon is happened to the food packaging bag and destroys structure thereof while losing considerable water vapor and the foods become too dried after heated to lose the original flavor thereof.

In addition, cooked foods made from flour, such as steamed meat buns, boiled dumplings, spaghetti, and etc., can be heated by a steam cooker or by microwave oven if the cooked foods are covered with a wrap film. The steam cooker can heat the cooked foods and maintain its original flavor while the cooked foods may absorb too much water vapor to become expanded or soggy and losing the taste. The microwave oven can quickly heat the cooked foods covered with the wrap film, but water contained in the cooked foods may evaporate to be quickly dissipated away. At this time, because the wrap film has an impermeable property and a lower dielectric constant, the conversion ratio from microwave energy into heat energy of the wrap film is less than that of some compositions with high dielectric constant of the cooked foods. Thereby, the temperature of the wrap film is lower than that of the cooked foods, and the water vapor dissipated from the cooked foods tends to condense on an inner surface of the wrap film with which the cooked foods are in contact. It is resulted in that a portion of the cooked foods in contact with the wrap film absorbs too much condensed water to become expanded and soggy while the other portion thereof loses too much water to become drier and harder so that heating by the microwave oven causes the cooked foods to lose its original flavor.

To prevent the air burst phenomenon caused by raising temperature too much during heating a sealed packaging material by microwaves, related development and research is continued. Various permeable materials are developed, and applied to waste water filtration, air purification, diaper, wet towel, medical material, and etc., but not to food packaging material for microwave heating. Conventional manufacturing methods for permeable materials are disclose in U.S. Pat. No. 3,378,507, U.S. Pat. No. 3,310,505, U.S. Pat. No. 3,607,793, U.S. Pat. No. 3,812,224, U.S. Pat. No. 4,247,498, U.S. Pat. No. 4,466,931, and U.S. Pat. No. 5,928,582, wherein the methods form a film made of at least two incompatible materials, and then remove one of the two materials by extraction so as to form a porous structure in the other remaining material capable of being applied to filtration and separation, such as separators in batteries for electrolytes passing therethrough, and dialytic films for water purification or desalination process of sea water. Due to the mechanical strength of a permeable material is in inverse proportion to porosity thereof, the permeable material may still have a danger about the air burst phenomenon when it is used as a food packaging material applied to microwave heating. In another aspect, if residues of the extracted material which should be removed during extraction were not completely removed, the high dielectric constant of the residues of extracted material might form heat spots due to convert microwave energy into heat energy during microwave heating so that the permeable material would be melted in the heat spots to form holes while the high volatile compositions contained in foods vast evaporate through the holes. Thereby, the permeable material made by the methods as described above is not suitable used as food packaging material applied to microwave heating, and its manufacturing cost is high while recycling of its extraction solutions was complicated. Another conventional permeable material is disclosed in U.S. Pat. No. 5,865,926, wherein non-woven fabric or fiber fabric with high permeability are used as permeable films, but the permeable films with high manufacturing cost have a macro porous property which limits the permeable films to only be applied to diaper or wet towel, but not to food packaging material for microwave heating.

Another conventional manufacturing methods for permeable materials are disclosed in U.S. Pat. No. 3,679,540, U.S. Pat. No. 4,187,390, U.S. Pat. No. 4,350,655, U.S. Pat. No. 4,466,931, U.S. Pat. No. 4,777,073, and U.S. Pat. No. 5,340,646, wherein inorganic powder, such as CaCO₃, TiO₂, or Al₂O₃, are uniformly mixed with at least one organic polymeric material, such as polyethylene, and then the mixture is extruded to form a permeable film. The mixture can be selectively processed by a coextruded die to form cylindrical elongated bags or blow bags; processed by a tenter; or processed by an extruder. These equipments are used to stretch the mixture to form a permeable film under a processing temperature close to a softening point temperature of the mixture. Although the permeable film made by the conventional manufacturing methods has micro porous structure, the conventional manufacturing methods has higher manufacturing cost, and more complicated processes while still having a danger about the air burst phenomenon during microwave heating to limit its practicability. Meanwhile, the inorganic powder has a low specific heat and a high dielectric constant so as to form heat spots to convert microwave energy into heat energy during microwave heating. It is resulted in that the permeable film would be melted in the heat spots to form holes while the high volatile compositions contained in foods would lose through the holes. It should be noted that the conventional manufacturing methods are difficult to control the consistency of porous quality of the permeable film such as elongation ratio, processing temperature, film thickness, and mixing ratio while the inorganic powder may contaminate the environment to cause a problem about environmental protection. Moreover, limit to the mixing compatibility of materials of the permeable film, the inorganic powder and the polymeric material may cause multiple phases to form an opaque permeable film. On the other hand, the conventional manufacturing methods need more complicated processes to form the permeable film.

Furthermore, when the permeable film is applied to food packaging material, the inorganic powder contained therein may contaminate foods within the food packaging material, and generate unpleasant odors. When the permeable film is in contact with oily or alcoholic foods, the permeable film cannot prevent oil or alcohol from passing therethrough while the permeable film absorbs the oil or alcohol therein. If the permeable film is used as a food packaging material with a pouch of oxygen scavenger, the oxygen scavenger may be covered with the oil or alcohol so as to lose its function to maintain food flavor and food freshness.

When heating or cooking a food, the food absorbs heat energy. If heating the food by microwaves, some compositions with high dielectric constant of the food such as water has a resonance effect and a high damping effect capable of converting microwave energy into heat energy for heating or cooking the food while raising internal temperature and build up pressure. Due to the permeable film has inorganic powders with a low specific heat, the inorganic powders may immediately form heat spots due to a converting microwave energy into heat energy during microwave heating so that the permeable film would be melted in the heat spots to form holes while a vast gaseous or liquid compositions contained in foods lose through the holes if the permeable film is used as a food packaging material. Furthermore, during accommodating foods or sterilizing under high temperature, the permeable film tends to peel off or break.

To overcome the problem about the air burst phenomenon of food packaging bags or containers, various permeable food packaging bags or containers are developed, and suitable to receive frozen foods or refrigerated foods and to be heated by microwaves without preopening the permeable food packaging bags or containers. However, the permeable food packaging bags or containers can only preserve foods a short time because those materials can not pack foods by at least one method of vacuum packaging or a process of modified atmosphere packaging (MAP) through purging with carbon dioxide (CO₂), nitrogen (N₂), or other inert gas for prolonging the shelf life of the foods.

The inventor of the present invention develops various food packaging bags or containers applied to microwave heating. Taiwan Invention Patent Publication No. 522123 discloses a packaging bag and manufacturing method therefore, wherein a permeable composite film is developed and used as food packaging bag for microwave heating to improve related problems of conventional permeable material. The permeable composite film provides convenience of operation, and ensures that water and soup content can be hold in foods without spattering onto inner walls of a microwave oven during microwave heating so as to reduce cleaning cost of the microwave oven. It is more important that the permeable composite film has a reversible permeability to automatically regulate a build up inner vapor pressure therein. Before microwave heating, the permeable composite film is in a normally substantially closed state. During microwave heating, the permeable composite film automatically regulates a build up inner steam pressure therein to prevent the air burst phenomenon. During cooling after stopping microwave heating, the permeable composite film restores to its normally substantially closed state. The reversible permeability about automatic regulation of the permeable composite film is in relation to the inner pressure and temperature therein so that the permeable composite film has a reusable property. The permeable composite film as described above is different from conventional food packaging bags which must be pre-formed with an opening by a destructive operation before microwave heating.

### SUMMARY OF THE INVENTION

A primary object of the present invention is to provide a composite film for packaging foods and the process of making it, wherein the composite film is applied to various food packaging bags or containers for receiving frozen foods or refrigerated foods followed by sealing the composite film, during general transportation, the food packaging bags or containers of the composite film maintaining an airtight state under a frozen condition, when taking the food packaging bags or containers out of the frozen condition, the food packaging bags or containers being directly heated by microwaves, boiling, or steaming to prepare the food for dining so as to prevent from the air burst phenomenon of the conventional food packaging bags or containers of sealed type which must be pre-pierced an opening or pre-opened before heating or cooking such as microwave heating.

To achieve the above object, the present invention provides a composite film for packaging foods enable to regulate pressure inside automatically when being heated, characterized in that the composite film comprises at least: a substrate film provided with a plurality of micro-gap regions having a plurality of micro gaps processed by impressing process; and an airtight film having a side surface and a dimension greater than that of the micro-gap region of the substrate film, the airtight film is uniformly coated by an adhesive layer correspondingly attached to the micro-gap region of the substrate film.

The present invention further provides a process of making a composite film for packaging foods, characterized in that the process comprises the steps of: forming a plurality of micro-gap regions with micro-gaps on a surface of a substrate film by impressing process; fabricating an airtight film having a dimension greater than that of the micro-gap region of the substrate film, and coating a adhesive layer on a side surface of the airtight film; and attaching the airtight film with the adhesive layer to the micro-gap region of the substrate film to constitute a composite film used to a food packaging device.

The composite film of the present invention is provided with various packaging advantages about convenience, quickness, and low power consumption for packaging frozen foods or refrigerated foods so that consumers such as students and nine-to-fivers can select various frozen foods or refrigerated foods packed by the composite film of the present invention as desired in a convenience store or a supermarket, and then store the frozen foods or refrigerated foods in a refrigerator until taking the frozen foods or refrigerated foods out of the refrigerator to heat by a microwave oven for dining and enjoying the delicious flavor of heated foods.

The present invention is related to Taiwan Invention Patent Publication No. 482722, No. 522123, and No. 542812, which are assigned to the inventor of the present invention, discloses a packaging bag and manufacturing method therefore, which disclose how to prepare the composite film of the present invention capable of automatically regulating a build up inner vapor pressure therein, wherein the process of the composite film is related to various integrated technologies such as impression rollers used to form specific micro gaps, extruded curtain coating machines, corona treatment machines, and coating machines.

As described above, the impressed structures such as impression rollers used to form the specific micro gaps are mainly adapted to manufacture a substrate film which plays a critical role capable of reversibly regulating a build-up inner vapor pressure in the composite film of the present invention. In operation, the stabbed structures are used to form a plurality of specific micro gaps on the substrate film. Preferably, the counts, shapes, distribution density, distribution locations of the specific micro gaps, and the thickness and materials of the substrate film can be adjusted to control the regulation degree of build-up high temperature pressurized steam in the substrate film. Moreover, the impressed structures are selected from both continuous-type impression cylinder roller sets and batch-type planar table-like impression machines, which are suitable for the impression process. The former, however, is more economical, and is more easily automated. The continuous-type impression cylinder assembly comprises an impression cylinder and one opposite cylinder. Both the cylinder roller set and planar table-like machine include an impresser and a transfer co-impresser. At least one of the two impressers comprises a plurality of fine protruding grains on the surface of the cylinder or plate (not shown). The protruding grains may be finished by at least one method as below, such as (1) by rigid wire brushes or needle rollers; (2) by uniformly electroplating polygonal diamond particles or rigid equivalent particles on the surface thereof; (3) by laser engraving on rigid organic blanks, metal blanks, or ceramic blanks to form the surface with the protrusions (i.e. ceramic anilox roll); (4) by mechanical tooling a metal surface with a predetermined hardness to form the protrusions followed by at least one surface hardening treatment such as high-temperature sintering and ultrasonic hardening to finish the protrusions of the metal surface; or (5) by chemically etching a metal surface via electrolysis to form the protrusions on the metal surface followed by surface hardening treatment to finish the protrusions thereof. In another aspect, the opposite cylinder or plate, i.e. the co-impresser, may be selected from metal, alloy, plastic steel, or ceramic material with suitable hardness. As described above, the surface finishing process of the protrusions of the impression cylinder (or the planar impresser) can be selectively carried out by the electroplated method, the mechanical tooling method, the laser engraving method, and etc. Then, the opposite rollers or the opposite co-impresser can be used to form the micro gaps on the substrate film, and the micro gaps can be selectively shaped in various configurations while providing with a suitable permeability for the substrate film. Preferably, the substrate film of the composite film finished by at least one method as described above can be processed to provide the desired heat-sealing property, self-venting function and specific designed structure. Furthermore, by means of selecting suitable materials, suitable stabbed structures or equivalent structures, and suitable environmental conditions of the surface finishing process, the composite film of the present invention can be optimized to fit the necessities of consumers. Moreover, the micro gaps of the substrate film of the composite film can be selectively distributed in various portions thereof if desired, such as entirely distributed, partially distributed, regularly distributed, or irregularly distributed, and the distribution modes and related structures of the micro gaps are flexibly dependent on selected materials of the substrate film, processing conditions, and etc.

In another aspect, the protrusions of the stabbed structures can be selectively shaped in various configurations, such as linear type, conical type, pyramidal type, cross type, and etc. After surface finishing by the stabbed structures, due to the nature of viscoelasticity and memory effect of polymeric material of the substrate film, most of the surface of the substrate film is substantially a plan except for permanent deformed regions with the micro gaps.

In one preferred embodiment of the present invention, the surface of the substrate film is optionally processed by calendaring rollers capable of temperature adjustment so as to level the surface thereof to form a pseudo-planar topography with the micro gaps which substantially closed and maintain the basic configurations, such as linear type, conical type, pyramidal type, cross type, or other type like slits or grooves. The super calendaring rollers with a temperature regulating function as described above are adapted to process the substrate film which becomes a uniformly planar structure with substantially equal thickness and fine appearance.

To achieve the above and other objects, the composite film for packaging foods of airtight type according to a preferred embodiment of the present invention comprises a substrate film having a plurality of micro gaps, wherein the geometric structure of the micro gaps being selected from various configurations with average size ranged from 0.1 micron to 3.0 millimeter while the adjacent opposite edges of the micro gaps are physically in contact with each other to form a normally substantially closed micro gap along the substrate film. The composite film further comprises an airtight sealant film used to cover a side surface of the substrate film with the micro gaps via an adhesive tie layer.

The adhesive tie layer of the composite film of a preferred embodiment of the present invention is selectively processed by curtain coating hot melt adhesive on the airtight layer film and laminated to the substrate film or a dry lamination process by gravure coating an adhesive solution onto the airtight sealant film, followed by drying and laminated to the substrate film so as to combine the airtight film with the substrate film with the micro gaps of the micro-gap region to constitute the composite film of the present invention capable of being applied to food packaging devices such as bags or containers. Meanwhile, the food packaging devices maintain an airtight state under a room temperature condition or a frozen condition. During microwave heating, the build-up high temperature pressurized steam evaporated from heated foods in the food packaging devices will penetrate through the micro-gap region of the substrate film, and be in contact with the adhesive layer of the airtight film adjacent to the substrate film so that the adhesive layer is gradually softened by the hot steam of water or oil of the heated foods. The strength of peel adhesion is gradually decreased and the airtight film will be automatically peeled from the substrate film. Due to the airtight film is peeled during microwave heating, a ventilation channel is formed on the peeled portion of the airtight film in relation to the substrate film so that the composite film is able to regulate the build up high temperature pressurized steam generated by heating the food packaging devices in order to prevent the air burst phenomenon. The build up over pressure is regulated through the micro-gap region along the substrate film and further release through the peel off ventilation channel. The present invention provides a composite film to manufacture food packaging bags or containers that have a novel packaging function to improve the related technological problem about the above mentioned related Patents in this filed. Before microwave heating, the composite film of the food packaging bags or containers of the present invention is in an airtight state. During microwave heating, the composite film of the food packaging bags or containers automatically regulates the build up high temperature pressurized steam generated by heating foods in the food packaging bags or containers by means of expanding the ventilating channel which is originally in a airtight state in relation to the substrate film and formed on a predetermined margin portion of the airtight film where only exists weaker adhesion strength so as to guide the build up high temperature pressurized steam to be released away from the food packaging bags or containers through a pressure regulating area to the atmosphere. Meanwhile, the food packaging bags or containers maintains the foods in a receiving portion thereof being efficiently heated under the build up high temperature pressurized steam while preventing the air burst phenomenon frequently occurred to the conventional food packaging bags or containers during microwave heating. During transporting, the food packaging bags or containers of the present invention can prevent juice of foods therein from leaking out of the food packaging bags or containers due to compression of any external force. In another aspect, the food packaging bags or containers are selectively provided in a vacuum packaging application or in a modified atmosphere packaging (MAP) application filled with inert gas, such as carbon dioxide (CO₂), nitrogen (N₂), and etc., so as to elongate the expiration time of the foods. Except for being applied to food packaging materials for packaging frozen foods or refrigerated foods, the composite film of the present invention can also be applied to food packaging materials of airtight type for packaging various fresh foods or cooked foods to provide a long-term fresh-keeping effect. During cooking, the food packaging bags or containers can be taken out of a freezer or refrigerator and directly heated by any cooking device, such as microwave ovens to prepare the foods for dining. With current invention, there is no need to thaw the foods; the food packaging bags or containers with the foods can be directly heated by full-power operation of the heater. It saves cooking time, energy, and cost for providing heated foods without causing the kitchen greasy or losing original food flavor and nutrients preservation.

To achieve another object, the present invention provides a food packaging material having a high permeability applied to microwave heating for solving the problems existed in the conventional food packaging materials applied to microwave heating. The food packaging material of the present invention can be selected from different predetermined functional materials dependent on necessities of consumers. The food packaging material is an environmental safe product, and can be degraded into water and carbon dioxide after incinerating to prevent any environmental pollution. Furthermore, the food packaging material will not contaminate the foods therein, and can prevent the foods from being contaminated by outer contaminants during microwave heating or cooking. Meanwhile, the food packaging material can prevent the air burst phenomenon caused by build up high temperature pressurized steam. The food packaging material manufactured by the process of the present invention can be normally used in a wider temperature range. Moreover, the specification of usage temperature, the dimension and the configuration of the food packaging material can be optimized and flexible adjusted dependent on foods and necessities of consumers.

To achieve another object, the present invention provides a permeable film applied to food packaging bags or containers which comprises a substrate film entirely or partially processed to form at least one micro-gap region, wherein the micro-gap region covered with an airtight film via a tie adhesive layer so that an airtight structure is formed between the substrate film and the airtight film to provide an airflow barrier. When foods in the food packaging bags or containers are heated to generate a build up high temperature pressurized steam, the adhesive layer adjacent to the substrate film will be softened by the hot steam of the heated foods. The adhesion strength will be gradually decreased, and then the airtight film will be automatically peeled from the substrate film. Furthermore, the substrate film will be expanded and deformed due to expansion caused by the pressurized hot steam so that the region with normally substantially closed micro gaps will be gradually expanded and becomes a safe pressure regulating area to prevent the air burst phenomenon caused by the build up high temperature pressurized steam gradually generated in the food packaging bags or containers during heating foods. Moreover, with the food packaging bags or containers with a high self-venting permeability, it is possible to be used to pack cooked foods and be stored under a frozen condition for preservation. Before dining, the food packing bags or containers with the foods can be directly heated by a heater such as a microwave oven a short time to prepare the foods followed by opening the food packing bags or containers for dining.

The structure and the technical means adopted by the present invention to achieve the above and other objects can be best understood by referring to the following detailed description of the preferred embodiments and the accompanying drawings, wherein:

### BRIEF DESCRIPTION OF THE DRAWINGS

FIG. 1 is a partially exploded perspective view of a composite film applied to a food packaging container according the present invention;

FIG. 2 is an assembled perspective view of the composite film applied to the food packaging container according to the present invention;

FIG. 3 is a cross-sectional view of the FIG. 2 taken along 10-10 line;

FIG. 4 is an assembled perspective view of the composite film applied to the food packaging container according to the first preferred embodiment of the present invention, wherein the airtight film is peeled from the substrate film due to the build up high temperature pressurized steam;

FIG. 5 is a partial exploded perspective view of a composite film applied to a food packaging bag according to the present invention;

FIG. 6 is an assembled perspective view of the composite film applied to the food packaging bag according to the present invention; and

FIG. 7 is an assembled perspective view of the composite film applied to the food packaging bag according to the present invention, wherein the airtight film is peeled from the substrate film due to the build up high temperature pressurized steam.

### DETAILED DESCRIPTION OF THE PREFERRED EMBODIMENTS

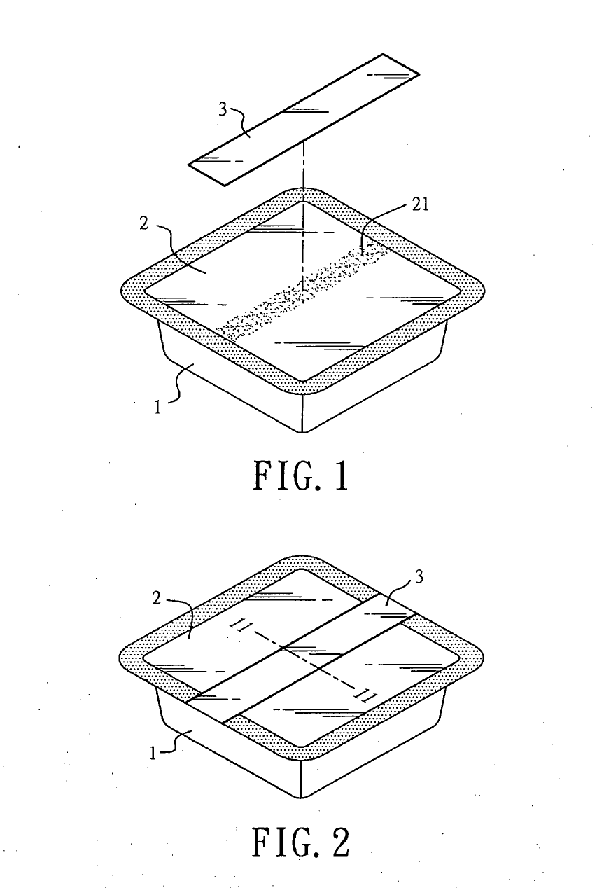

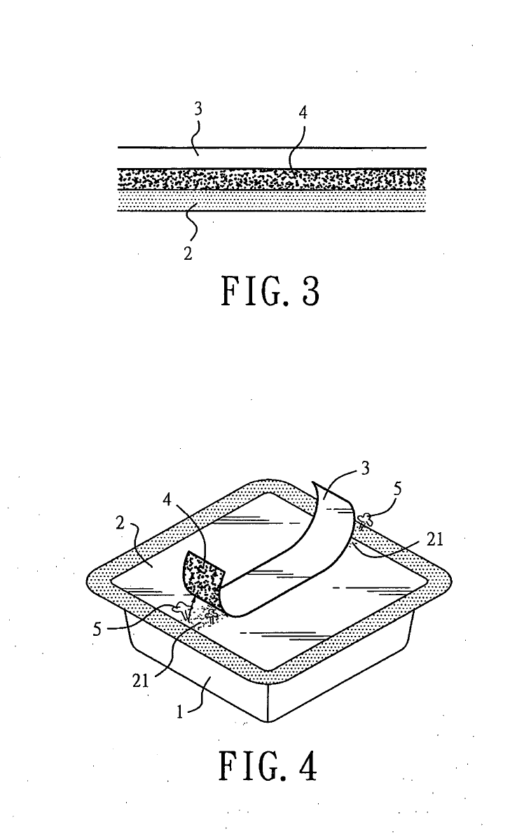

Referring now to FIGS. 1, 2 and 3, a composite film for packaging foods and the process of making it according to a first preferred embodiment of the present invention is illustrated. As shown, the composite film for packaging foods of the present invention is applied to a food packaging container 1 for packaging various frozen foods or refrigerated foods. A substrate film 2 having an impermeable property is attached to a rim of an opening of the food packaging container 1 by heat seal pressing to the flanges. Before attached to the food packaging container 1, the substrate film 2 is pre-formed with at least one predetermined micro-gap region 21 processed by a tooling method. The dimension of the airtight film 3 is greater than and dependent on that of the micro-gap region 21. An adhesive layer 4 is uniformly coated on a side surface of the airtight film 3 corresponding to the micro-gap region 21, as shown in FIG. 3. In other words, the adhesive layer 4 on the airtight film 3 is correspondingly attached to the micro-gap region 21 of the substrate film 2, as shown in FIG. 2, so that the food packaging container 1, the substrate film 2, and the airtight film 3 with the adhesive layer 4 to seal the micro-gap region 21 are combined into a unit.

Referring now to FIG. 4, the food packaging container 1 covered with the substrate film 2 is used to receive frozen foods or refrigerated foods. During microwave heating, the foods are heated to generate a high temperature pressurized steam 5, and the steam 5 is regulated through the micro-gap region 21 of the substrate film 2 so that the neighbouring adhesive layer 4 is gradually softened by the hot steam 5 to decrease the adhesion strength gradually until two ends of the airtight film 3 are automatically and partially peeled from the substrate film 2. Thus, a portion of the high temperature pressurized steam 5 in the food packaging container 1 is regulated to the atmosphere through an exposed portion of the micro-gap region 21 where is not covered by the airtight film 3 so as to suitably regulate the build up high temperature pressurized steam 5 in the food packaging container 1 along the exposed portion of the micro-gap region 21 to prevent the air burst phenomenon to the food packaging container 1 while preserving most of the hot steam 5 in the food packaging container 1 and preventing the heated foods from becoming drier to maintain the original flavor thereof.

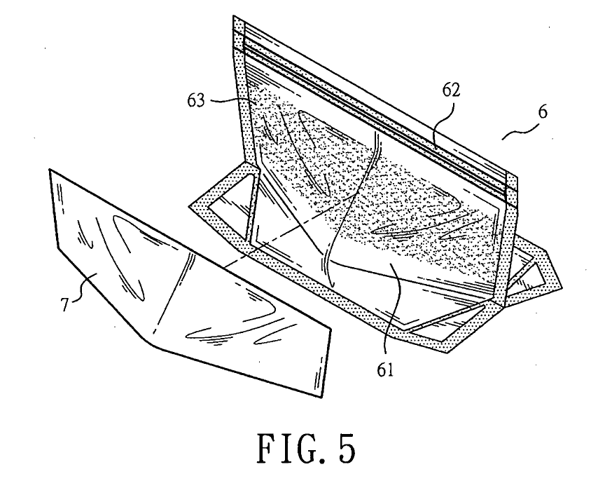

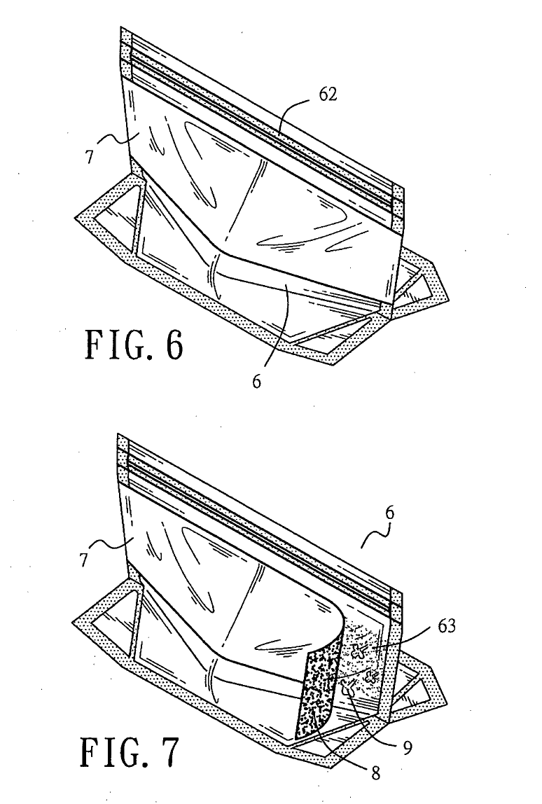

Referring now to FIGS. 5, 6 and 7, a composite film for packaging foods and the process of making it according to a second preferred embodiment of the present invention is illustrated. As shown, the composite film for packaging foods of the present invention is used to manufacture a food packaging bag 6 for packaging various frozen foods or refrigerated foods. A substrate film 61 with a predetermined bag configuration is a body of the food packaging bag 6 having a heat-resistant and self-venting property. Moreover, the substrate film 61 is formed with an opening end having a reclosable profile 62, which is preferably selected from a zipper profile. After the food packaging bag 6 receives frozen foods or refrigerated foods, the reclosable profile 62 is convenient to selectively seal up the food packaging bag 6. The substrate film 61 with the self-venting area can be selectively used to form an entire structure or a portion of the food packaging bag 6 such as a side of the food packaging bag 6. Before shaped in the bag configuration, the substrate film 61 is pre-formed with at least one micro-gap region 63 and a predetermined dimension by an impression process while the dimension of an airtight film 7 is greater than and dependent on that of the micro-gap region 63. An adhesive layer 8 is uniformly coated on a side surface of the airtight film 7 corresponding to the micro-gap region 63, as shown in FIG. 7. In other words, the adhesive layer 8 on the airtight film 7 is correspondingly attached to the micro-gap region 63 of the substrate film 61 so that the substrate film 61 of the food packaging bag 6 and the airtight film 7 with the adhesive layer 8 are combined into a unit.

Referring now to FIG. 7, the food packaging bag 6 is used to receive frozen foods or refrigerated foods. During microwave heating, the foods are heated to generate high temperature pressurized steam 9, and the build up high temperature pressurized steam 9 is regulated through the micro-gap region 63 of the substrate film 61 so that the neighbouring adhesive layer 8 is gradually softened by the high temperature pressurized steam 9 to decrease the adhesion strength of the adhesive layer 8 until two ends of the airtight film 7 are automatically and partially peeled from the substrate film 61. Thus, the high temperature pressurized steam 9 in the food packaging bag 6 is released to the atmosphere through an exposed portion of the micro-gap region 63 where is separated from the airtight film 7 so as to suitably regulate the high temperature pressurized steam 9 in the food packaging bag 6 along the exposed portion of the micro-gap region 63 to prevent the air burst phenomenon of the food packaging bag 6 while retaining most of the hot steam in the food packaging bag 6 and preventing the heated foods from becoming drier to maintain the original flavor thereof.

The substrate film 2 (or 61) of the food packaging container 1 (or the food packaging bag 6) is made of at least one material selected from the group consisting of acrylic resin, polyester, polyethylene (PE), polypropylene (PP), polyamide, ethylene-styrene copolymer (ES), cyclo-olefin, polyethylene terephthalate (PET), polyvinyl alcohol (PVA), ethylene-vinyl acetate (EVA), ethylene vinyl alcohol (EVOH), ionomer, polyethylene naphthalate (PEN), poly ether ether ketone (PEEK), polycarbonate (PC), polysulfone, polyimide (PI), polyacrylonitrile (PAN), styrene acrylonitrile (SAN), polyurethane (PU), nylon, waxed paper, multi-layer co-extruded stretching film, synthetic paper, glassine paper, polyolefin-coated paper, paper, and the combination thereof.

The airtight film attached to the micro-gap region 21 (or 63) of the substrate film 2 (or 61) is made of at least one material selected from the group consisting of polyolefin, polyethylene (PE), polypropylene (PP) polyester film, polyethylene terephthalate (PET), polystyrene, polyvinyl chloride (PVC), polyethylene naphthalate (PEN), poly ether ether ketone (PEEK), polycarbonate (PC), polyimide (PI), polysulfone, polyacrylonitrile (PAN), acrylic resin, polyethylene-polypropylene copolymer, ethylene-styrene copolymer (ES), cyclo-olefin, polyvinyl alcohol (PVA), ethylene-vinyl acetate (EVA), ethylene vinyl alcohol (EVOH), styrene acrylonitrile (SAN), polyurethane (PU), nylon, polyamide, ionomer, synthetic paper, waxed paper, polyethylene non-woven fabric, polypropylene non-woven fabric, plastic film with inorganic dopant, multi-layer co-extruded stretching film, multi-layer composite, and the combination thereof.

Alternatively, the airtight film is a multi-layer film which is selected from the group consisting of plastic film attached with a metal layer or plastic film vapor coated with a metal layer, wherein the metal layer therein can be selected from aluminum or aluminum alloy thereof.

The adhesive layer uniformly attached to the airtight film applied to the substrate film 2 of the food packaging container 1 or the substrate film 61 of the food packaging bag 6 is made of at least one material selected from the group consisting of polyacrylics, polyester, polyolefin, polyethylene (PE), polypropylene (PP), cyclo-olefin, polyvinyl alcohol (PVA), ethylene-vinyl acetate (EVA), ethylene vinyl alcohol (EVOH), polyolefin derivative adhesive, polyamide, polyurethane (PU), styrene-butadiene copolymer, polyethylene-polypropylene copolymer, ethylene-styrene copolymer (ES), single-component primer, dual component primer, rubber, hot melt elastomer, silicone elastomer, ionomer, thermal plastic rubber, natural wax such as carnauba, paraffin, microcrystalline wax, propolis, and rice bran wax, man-made wax or synthetic wax derivated from polyethylene, polypropylene, poly(ethylene oxide), oxide of petrochemical substance, oxide of mineral oil, oxide of polyolefin, or oxide of wax, fatty acid, derivatives of fatty acid, starch, derivatives of starch, and the combination thereof. Furthermore, the adhesive layer may entirely or partially cover on the micro-gap region of the substrate film.

The area of the micro-gap region 21 (or 63) may be entirely or partially distributed on a surface of the substrate film 2 on the food packaging container 1 (or the substrate film 61 of the food packaging bag 6).

The adhesive layer on a side surface of the airtight film applied to the substrate film 2 of the food packaging container 1 or the substrate film 61 of the food packaging bag 6 may be coated by at least one coating method, such as coating an adhesive solution on the airtight film followed by drying; by directly coating a hot melt elastomer on the airtight film; or by hot pressing.

When using the food packaging container or the food packaging bag according to the present invention for packaging foods, the packed foods may comprise a solid like portion, such as rice or noodle, and a liquid like portion, such as sauce, both of which must be separated from each other in a preserved condition of room temperature, a frozen condition, or a refrigerated condition to prevent ruining the food due to a mixing with the solid like portion and the liquid like portion during preservation and transportation. To overcome the problem as described above, according to a preferred embodiment of the present invention, the liquid like portion of the foods can be pre-packed in an airtight packaging container or bag (not shown), and then the solid like portion of the foods and the liquid packaging container or bag can be commonly received in a food packaging device of the present invention, such as the food packaging container or the food packaging bag. Thereby, during microwave heating, a sealing film (not shown) of the liquid packaging container or bag will be softened and opened therefrom prior to the peeling function of the airtight film of the food packaging container or the food packaging bag so that the liquid like portion will be released from the liquid packaging container or bag to mix with the solid portion of the foods for commonly being heated.

The present invention has been explained and illustrated in the preferred embodiments as described above while not limiting to the preferred embodiments. In another aspect, the permeable composite film of the present invention can be selectively formed in various structures such as back sealed bags, gadget bags, three-sides seal bags, standup pouches, and etc.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A composite film for packaging foods which can regulating an inside pressure automatically when being heated, characterized in that the composite film comprises at least:
a substrate film provided with a plurality of micro-gap regions having a plurality of micro gaps processed by impressing process; and
an airtight film having a side surface and a dimension greater than that of the micro-gap region of the substrate film, the airtight film is uniformly coated by an adhesive layer correspondingly attached to the micro-gap region of the substrate film.

2. The composite film for packaging foods of claim 1, characterized in that said substrate film is made of at least one material selected from the group consisting of acrylic resin, polyester, polyethylene, polypropylene, polyamide, ethylene-styrene copolymer, cyclo-olefin, polyethylene terephthalate, polyvinyl alcohol, ethylene-vinyl acetate, ethylene vinyl alcohol, ionomer, polyethylenenaphthalate, poly ether ether ketone, polycarbonate, polysulfone, polyimide, polyacrylonitrile, styrene acrylonitrile, polyurethane, nylon, waxed paper, multi-layer co-extruded stretching film, synthetic paper, glassine paper, polyolefin-coated paper, paper, and the combination thereof.

3. The composite film for packaging foods of claim 1, characterized in that said airtight film is made of at least one material selected from the group consisting of polyolefin, polyethylene, polypropylene, polyester film, polyethylene terephthalate, polystyrene, polyvinyl chloride, polyethylene naphthalate, poly ether ether ketone, polycarbonate, polyimide, polysulfone, polyacrylonitrile, acrylic resin, polyethylene-polypropylene copolymer, ethylene-styrene copolymer, cyclo-olefin, polyvinyl alcohol, ethylene-vinyl acetate, ethylene vinyl alcohol, styrene acrylonitrile, polyurethane, nylon, polyamide, ionomer, synthetic paper, waxed paper, polyethylene non-woven fabric, polypropylene non-woven fabric, plastic film with inorganic dopant, multi-layer co-extruded stretching film, multi-layer composite, and the combination thereof.

4. The composite film for packaging foods of claim 1, characterized in that said airtight film is selected from the group consisting of a plastic film attached with a metal layer or a plastic film vapor coated with a metal layer.

5. The composite film for packaging foods of claim 4, characterized in that said metal layer is selected from aluminum or aluminum alloy thereof.

6. The composite film for packaging foods of claim 1, characterized in that said adhesive layer is made of at least one material selected from the group consisting of polyacrylics, polyester, polyolefin, polyethylene, polypropylene, cyclo-olefin, polyvinyl alcohol, ethylene-vinyl acetate, ethylene vinyl alcohol, polyolefin derivative adhesive, polyamide, polyurethane, styrene-butadiene copolymer, polyethylene-polypropylene copolymer, ethylene-styrene copolymer, single-component primer, dual component primer, rubber, hot melt elastomer, silicone elastomer, ionomer, thermal plastic rubber, natural wax, carnauba, paraffin, microcrystalline wax, propolis, rice bran wax, polyethylene synthetic wax, polypropylene synthetic wax, poly(ethylene oxide) synthetic wax, synthetic wax of oxide of petrochemical substance, synthetic wax of oxide of mineral oil, synthetic wax of oxide of polyolefin, synthetic wax of oxide of wax, fatty acid, derivatives of fatty acid, starch, derivatives of starch, and the combination thereof.

7. The composite film for packaging foods of claim 1, characterized in that the composite is applied to a food packaging container or a food packaging bag for receiving the frozen foods or the refrigerated.

8. The composite film for packaging foods of claim 7, characterized in that said food packaging container or said food packaging bag further comprises a liquid packaging container or bag.

9. The composite film for packaging foods of claim 1, characterized in that said substrate film is entirely or partially formed with the micro-gap region.

10. The composite film for packaging foods of claim 1, characterized in that said adhesive layer is entirely or partially covered on the micro-gap region of the substrate film.

11. A process of making a composite film for packaging foods, characterized in that the process comprises the steps of:
forming a plurality of micro-gap regions with micro-gaps on a surface of a substrate film by impressing process;
fabricating an airtight film having a dimension greater than that of the micro-gap region of the substrate film, and coating a adhesive layer on a side surface of the airtight film; and
attaching the airtight film with the adhesive layer to the micro-gap region of the substrate film to constitute a composite film used to a food packaging device.

12. The process of claimed in claim 11, characterized in that said adhesive layer is coated on the side surface of the airtight film by coating an adhesive solution on the side surface of the sealing film followed by drying, or by directly coating a hot melt elastomer on the side surface of the airtight film.
